(19) United States
(12) Patent Application Publication
(10) Pub. No.: US 2010/0276020 A1
(43) Pub. Date: Nov. 4, 2010

(54) SHOWER ROD ASSEMBLY

(76) Inventors: Kun-Jing FAN, Jiujiang (CN); Shi-Bing WU, Xiamen City (CN)

Correspondence Address: Dr. BANGER SHIA;Patent Office of Bang Shia, 102 Lindencrest Ct., Sugar Land, TX, 77479-5201, US

(21) Appl. No.: 12/563,024

(22) Filed: Sep. 18, 2009

(30) Foreign Application Priority Data
Apr. 29, 2009 (CN) 200920138126X

(51) Int. Cl. F16K 11/20

(52) U.S. Cl. 137/597

(57) ABSTRACT

A shower rod assembly includes a shower rod connected with a water supply pipe, a shower head connected with the shower rod, and a retaining seat to secure the shower rod. The shower head has at least two water supply portions. The shower rod has at least two water passages therein to connect with the water supply portions of the shower head, respectively. The shower rod is provided with a water passage switch device. The water passage switch device has an inlet connecting with the water supply pipe and at least two outlets connecting with the two water passages of the shower rod. The water passage switch device is adapted to control interconnection of the two outlets and the inlet. The present invention is operated with ease, and is convenient when in use so as to satisfy a user's demand.

### BACKGROUND OF THE INVENTION

1. Field of the Invention

The present invention relates to a shower bath appliance, and more particularly to a shower rod assembly capable of changing waterways of a shower head.

2. Description of the Prior Art

A conventional shower rod assembly is used to connect with a spray nozzle and a shower head. The spray nozzle is connected with a hose to for spraying water freely. The shower head is connected to the top of the shower rod, which is fixed at the outlet of the shower rod. A switch is provided between an inlet tube of the spray nozzle and the shower head for controlling water to flow through the spray nozzle or through the shower head. When a user takes a shower, he/she can have a choice through the switch. However, the conventional shower head only has one outflow mode. Even a shower head having a multi-function outflow mode is replaced, a child or a person who is not tall enough is unable to switch the outflow mode because of the height of the shower head.

Accordingly, the inventor of the present invention has devoted himself based on his many years of practical experiences to solve this problem.

### SUMMARY OF THE INVENTION

The primary object of the present invention is to provide a shower rod assembly, which provides a multi-function outflow mode and is convenient to switch.

According to the present invention, there is provided a shower rod assembly, comprising a shower rod connected with a water supply pipe, a shower head connected with the shower rod, and a retaining seat to secure the shower rod; the shower head having at least two water supply portions; the shower rod having at least two water passages therein to connect with the water supply portions of the shower head, respectively; the shower rod being provided with a water passage switch device, the water passage switch device having an inlet connecting with the water supply pipe and at least two outlets connecting with the two water passages of the shower rod, the water passage switch device being adapted to control interconnection of the two outlets and the inlet.

Preferably, the water passage switch device comprises a valve seat, a valve core, a knob, and a lid; the two outlets being disposed at an upper end of the valve seat for connecting with the two water passages of the shower rod, the inlet being disposed at a lower end of the valve seat for connecting with the water supply pipe, one side of the valve seat being provided with the knob, the knob having a shaft to connect with the valve core of the valve seat, the knob being rotated to drive the valve core for switching waterways from the inlet to the two outlets of the valve seat, another side of the valve seat being provided with the lid.

Preferably, the valve seat is a tubular body having a partition therein, the partition being formed with at least two inlets to connect with the outlets at the top of the valve seat, respectively, the partition being provided with an annular projection extending from a central portion thereof, the annular projection being hollow and having a through hole which is interconnected with the inlet at the bottom of the valve seat, the valve core being formed with a valve cover at a central portion thereof, the valve cover being rotated to fit on the annular projection of the valve seat, the valve cover having at least one outlet passage extending outwardly from a side wall thereof, the valve core further having a seal plate on top of the valve cover to form an airtight chamber between the valve cover and the outlet passage, the outlet passage of the valve cover having one end leaning on the partition of the valve seat and another end leaning on the seal plate, two gaskets being provided between the outlet passage and the partition.

Preferably, a connecting seat is provided between the two outlets of the valve seat and the two water passages in the shower rod for connection of the two outlets and the two water passages in the shower rod.

Preferably, the valve cover has two outlet passages extending outwardly from the side wall thereof.

Preferably, the shower head and the shower rod are connected with a ball-shaped joint, the ball-shaped joint being hollow and having two separate waterways to interconnect with the two water passages in the shower rod and two inlets of the two water supply portions of the shower head, respectively.

Preferably, a joint seat is provided between the shower rod and a connecting end of the ball-shaped joint for interconnecting with the water passages of the shower rod; the ball-shaped joint having a dividing ring formed with two through holes, the dividing ring having one end interconnecting with the two water passages of the shower rod and another end interconnecting with the two inlets of the two water supply portions of the shower head.

Preferably, one of the through holes of the dividing ring is provided with a hose connector, the hose connector being connected with one end of a hose, another end of the hose being connected with the inlet of one of the two water supply portions of the shower head.

Preferably, the water supply pipe is disposed on the top of the shower rod, and the shower rod further comprises another water passage to connect with the inlet of the water passage switch device.

Preferably, the water passage switch device comprises a valve seat, a valve core, a knob, and a lid; the two outlets and the inlet being disposed at an upper end of the valve seat for connecting with the three water passages in the shower rod, the inlet being connected with the water supply pipe through one of the water passages in the shower rod, one side of the valve seat being provided with the knob, the knob having a shaft to connect with the valve core in the valve seat, the knob being rotated to drive the valve core for switching waterways from the inlet to the outlets of the valve seat, another side of the valve seat being provided with the lid.

Preferably, the valve seat has another outlet at a side wall thereof for connecting with outlet passages of the valve core and the hand-held spray nozzle.

Preferably, the water passages of the shower rod are in the form of plastic hoses or nylon tubes.

The improvements of the present invention are that the shower head at the top of the shower rod has two water supply portions; the shower rod has a number of separate water passages therein for interconnecting with the two water supply portions of the shower head, respectively; the water passage switch device disposed at the bottom of the shower rod is adapted to switch different water outflow modes. The present invention is operated with ease, and is convenient when in use so as to satisfy a user's demand.

### BRIEF DESCRIPTION OF THE DRAWINGS

FIG. 1 is a cross-sectional view according to a first embodiment of the present invention;

FIG. 2 is an exploded view of a water passage switch device according to the first embodiment of the present invention;

FIG. 3 is a cross-sectional view of a shower head according to the first embodiment of the present invention;

FIG. 4 is a cross-sectional view according to a second embodiment of the present invention; and

FIG. 5 is an exploded view of a water passage switch device according to the second embodiment of the present invention.

### DETAILED DESCRIPTION OF THE PREFERRED EMBODIMENTS

Embodiments of the present invention will now be described, by way of example only, with reference to the accompanying drawings.

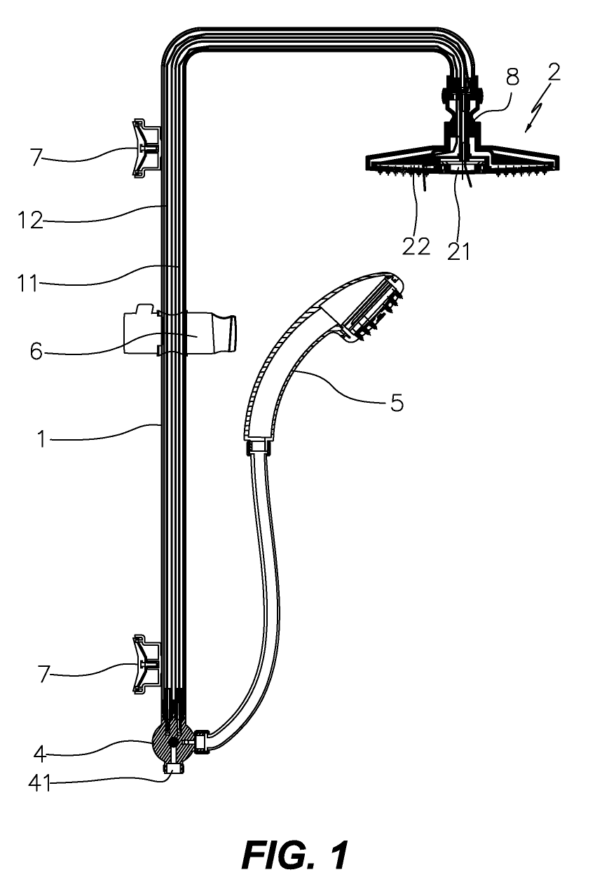

As shown in FIG. 1, a shower rod assembly according to a first embodiment of the present invention comprises a shower rod 1, a shower head 2, a water supply pipe (not shown in the drawing), a water passage switch device 4, a hand-held spray nozzle 5, a slide sleeve 6, and a retaining seat 7. In this embodiment, the water supply pipe is disposed under a lower end of the shower rod. The shower head 2 has a first to water supply portion 21 and a second water supply portion 22. The shower rod 1 has a first water passage 11 and a second water passage 12 therein. The first water passage 11 and the second passage 12 are in the form of plastic hoses or nylon tubes. The shower rod 1 is provided with the water passage switch device 4. The water passage switch device 4 has an inlet 41 and at least two outlets 42, 43. The inlet 41 is connected with the water supply pipe. The two outlets 42, 43 are connected with the first water passage 11 and the second water passage 12 of the shower rod 1, respectively. The water passage switch device 4 is used to control interconnection of the two outlets 42, 43 and the inlet 41.

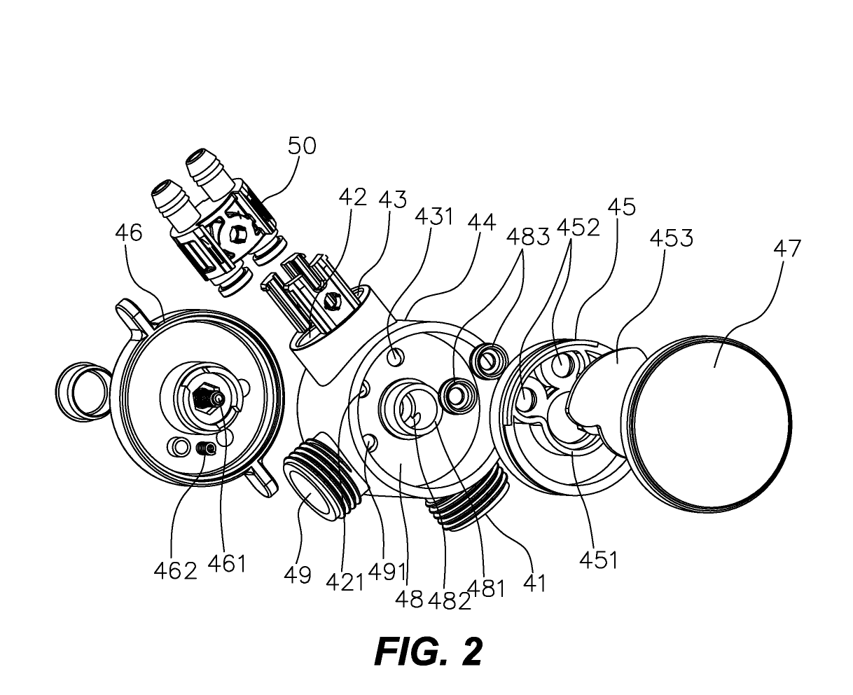

As shown in FIG. 2, the water passage switch device 4 comprises a valve seat 44, a valve core 45, a knob 46, and a lid 47.

The valve seat 44 is a tubular body. The two outlets 42, 43 are disposed at an upper end of the valve seat 44. A connecting seat 50 is provided between the two outlets 42, 43 and the two water passages 11, 12 in the shower rod 1 for connection of the two outlets 42, 43 and the two water passages 11, 12 in the shower rod 1. The inlet 41 is disposed at a lower end of the valve seat 44 for connecting with the water supply pipe (not shown in the drawings). The valve seat 44 has another outlet 49 at a side wall thereof for connecting with the hand-held spray nozzle 5. The valve seat 44 has a partition 48 therein. The partition 48 is formed with three inlets 421, 431, 491 to connect with the outlets 42, 43, 49 of the valve seat 44, respectively. The partition 48 is provided with an annular projection 481 extending from a central portion thereof. The annular projection 481 is hollow, and has a through hole 482 which is interconnected with the inlet 41 of the valve seat 44.

The valve core 45 is formed with a valve cover 451 at a central portion thereof. The valve cover 451 is rotated to fit on the annular projection 481 of the valve seat 44. The valve cover 451 has two outlet passages 452 extending outwardly from a side wall thereof. The valve core 45 further has a seal plate 453 on top of the valve cover 451 to form an airtight chamber between the valve cover 451 and the two outlet passages 452. Each of the outlet passages 452 of the valve cover 451 has one end leaning on the partition 48 of the valve seat 44 and another end leaning on the seal plate 453. Two gaskets 483 are provided between the outlet passages 452 and the partition 48. One side of the valve seat 44 is provided with the knob 46. The knob 46 has a shaft 461 to connect with the valve core 45 in the valve seat 44. The knob 46 is rotated to drive the valve core 45 for changing the positions of the outlet passages 452 of the valve cover 451 with respect to the inlets 421, 431, 491 of the partition 48 so as to switch waterways of the inlet 41 and the outlets 42, 43 of the valve seat 44. Another side of the valve seat 44 is provided with the lid 47.

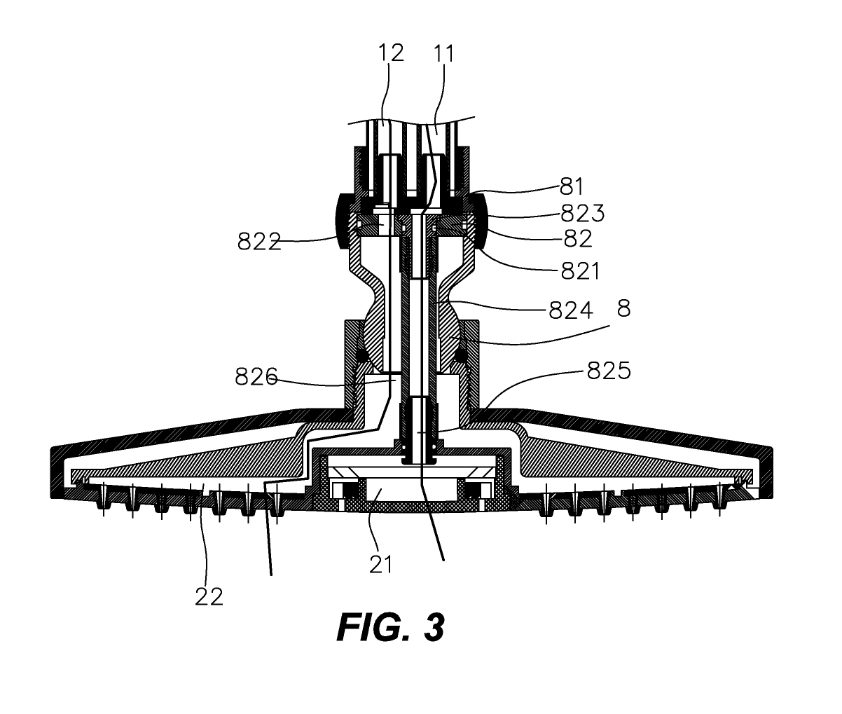

As shown in FIG. 3, the shower head 2 and the shower rod 1 are connected with a ball-shaped joint 8. A joint seat 81 is provided between the shower rod 1 and a connecting end of the ball-shaped joint 8 for interconnecting with the water passages 11, 12 of the shower rod 1. The ball-shaped joint 8 is hollow, and has a dividing ring 82 formed with two through holes 821, 822. The dividing ring 82 has one end interconnecting with the two water passages 11, 12 of the shower rod 1 and another end interconnecting with the first and second water supply portions 21, 22 of the shower head 2. The through hole 821 of the dividing ring 82 is provided with a hose connector 823. The hose connector 823 is connected with one end of a hose 824. Another end of the hose 824 is connected with an inlet 825 of the first water supply portion 21 of the shower head 2 so that the through hole 821 of the dividing ring 82 and the inlet 825 of the first water supply portion 21 of the shower head 2 are to form a first waterway. The through hole 822 of the dividing ring 82 and an inlet 826 of the second water supply portion 22 of the shower head 2 are to form a second waterway.

According to the aforesaid structure, there are three separate waterways in the shower rod assembly. One is from the inlet 41 interconnecting with the outlet 49 at the side wall of the valve seat 44 to the hand-held spray nozzle 5; another is from the inlet 41 interconnecting with the outlet 43 at the top of the valve seat 44 and the first water passage 11 of the shower rod 1 to the inlet 825 of the first water supply portion 21 of the shower head 2; and the other is from the inlet 41 interconnecting with the outlet 42 at the top of the valve seat 44 and the second water passage 11 of the shower rod 1 to the inlet 826 of the second water supply portion 22 of the shower head 2. By rotating the knob 46 of the water passage switch device 4, the waterways from the inlet 41 to the outlets 42, 43, 49 are changeable. The shower rod assembly provides two water outflow modes for water to flow through the hand-held spray nozzle 5 or through the shower head 2.

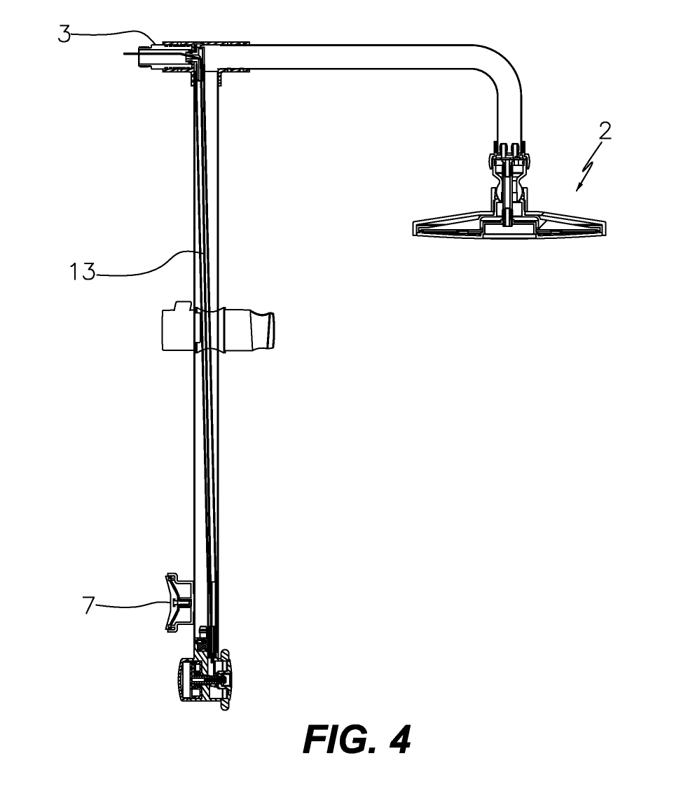

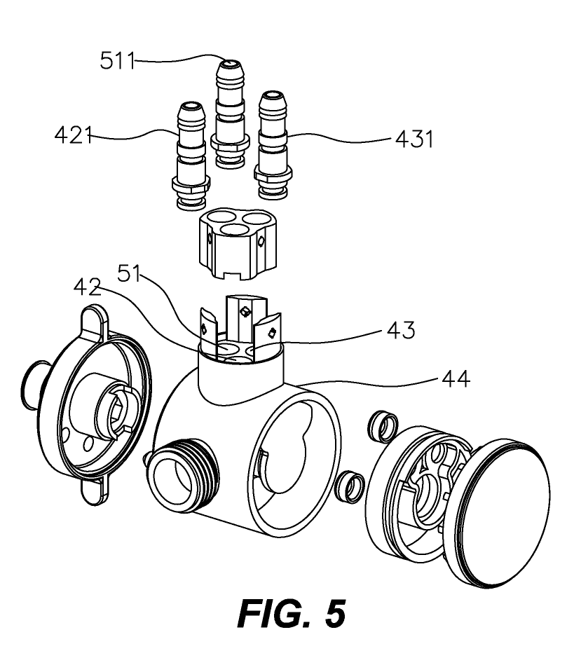

FIGS. 4 and 5 show a second embodiment of the present invention, which is substantially similar to the first embodiment with the exceptions described hereinafter. In this embodiment, the water supply pipe is disposed at the top of the shower rod 1. The shower rod 1 further comprises a third water passage 13 to connect with the water supply pipe 3. The valve seat 44 of the water passage switch device 4 further has another inlet 51 to connect with the third water passage 13. Water is supplied from the top of the valve seat, not from the bottom of the valve seat.

The improvements of the present invention are that the shower head at the top of the shower rod has two water supply portions; the shower rod has a number of separate water passages therein for interconnecting with the two water supply portions of the shower head, respectively; the water passage switch device disposed at the bottom of the shower rod is adapted to switch different water outflow modes. The present invention is operated with ease, and is convenient when in use so as to satisfy a user's demand.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A shower rod assembly, comprising a shower rod connected with a water supply pipe, a shower head connected with the shower rod, and a retaining seat to secure the shower rod; the shower head having at least two water supply portions; the shower rod having at least two water passages therein to connect with the water supply portions of the shower head, respectively; the shower rod being provided with a water passage switch device, the water passage switch device having an inlet connecting with the water supply pipe and at least two outlets connecting with the two water passages of the shower rod, the water passage switch device being adapted to control interconnection of the two outlets and the inlet.

2. The shower rod assembly as claimed in claim 1, wherein the water passage switch device comprises a valve seat, a valve core, a knob, and a lid; the two outlets being disposed at an upper end of the valve seat for connecting with the two water passages of the shower rod, the inlet being disposed at a lower end of the valve seat for connecting with the water supply pipe, one side of the valve seat being provided with the knob, the knob having a shaft to connect with the valve core of the valve seat, the knob being rotated to drive the valve core for switching waterways from the inlet to the two outlets of the valve seat, another side of the valve seat being provided with the lid.

3. The shower rod assembly as claimed in claim 2, wherein a connecting seat is provided between the two outlets of the valve seat and the two water passages in the shower rod for connection of the two outlets and the two water passages in the shower rod.

4. The shower rod assembly as claimed in claim 2, wherein the valve seat of the water passage switch device has a side wall provided with an outlet which is interconnected with the outlet passage of the valve core.

5. The shower rod assembly as claimed in claim 1, wherein the shower head and the shower rod are connected with a ball-shaped joint, the ball-shaped joint being hollow and having two separate waterways to interconnect with the two water passages in the shower rod and two inlets of the two water supply portions of the shower head, respectively.

6. The shower rod assembly as claimed in claim 5, wherein a joint seat is provided between the shower rod and a connecting end of the ball-shaped joint for interconnecting with the water passages of the shower rod; the ball-shaped joint having a dividing ring formed with two through holes, the dividing ring having one end interconnecting with the two water passages of the shower rod and another end interconnecting with the two inlets of the two water supply portions of the shower head.

7. The shower rod assembly as claimed in claim 6, wherein one of the through holes of the dividing ring is provided with a hose connector, the hose connector being connected with one end of a hose, another end of the hose being connected with the inlet of one of the two water supply portions of the shower head.

8. The shower rod assembly as claimed in claim 1, wherein the water supply pipe is disposed on the top of the shower rod, and the shower rod further comprises another water passage to connect with the inlet of the water passage switch device.

9. The shower rod assembly as claimed in claim 8, wherein the water passage switch device comprises a valve seat, a valve core, a knob, and a lid; the two outlets and the inlet being disposed at an upper end of the valve seat for connecting with the three water passages in the shower rod, the inlet being connected with the water supply pipe through one of the water passages in the shower rod, one side of the valve seat being provided with the knob, the knob having a shaft to connect with the valve core in the valve seat, the knob being rotated to drive the valve core for switching waterways from the inlet to the outlets of the valve seat, another side of the valve seat being provided with the lid.

10. The shower rod assembly as claimed in claim 9, wherein the valve seat has another outlet at a side wall thereof for connecting with outlet passages of the valve core.

11. The shower rod assembly as claimed in claim 1, wherein the water passages of the shower rod are in the form of plastic hoses or nylon tubes.
